(19) United States
(12) Patent Application Publication
(10) Pub. No.: US 2007/0077913 A1
(43) Pub. Date: Apr. 5, 2007

(54) Mobile communication terminal, control method thereof, and method for controlling mobile communication service

(75) Inventor: So Young Kim, Gunpo (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/540,730

(22) Filed: Oct. 2, 2006

(30) Foreign Application Priority Data
Oct. 1, 2005 (KR) 10-2005-0092671

(51) Int. Cl. H04M 3/16

(52) U.S. Cl. 455/410; 455/419

(57) ABSTRACT

A mobile communication method including a transmitting at a first terminal, a message including a control command for controlling a service of a second terminal to a network, and controlling the service of the second terminal according to the control command.

This application claims priority to the Korean Patent Application No. 10-2005-0092671, filed in Korea on Oct. 1, 2005, which is hereby incorporated by reference in its entirety.

### BACKGROUND OF THE INVENTION

1. Field of the Invention

The present invention relates to a mobile communication terminal and corresponding method that allows a user to control his or her terminal by issuing a control command from another mobile terminal.

2. Description of the Background Art

Mobile terminals are small in size and weight and therefore very convenient. However, because the terminals are small in size and weight, the terminals are also sometimes lost by a user. When a user loses his or her terminal, the user has to contact the appropriate communication provider (SPRINT, CINGULAR, etc.) and request the provider cancel or block the lost terminal. This process is generally done over the telephone or by visiting the local provider store. However, this process is inconvenient to the user and also can take a considerable amount of time.

In addition, someone who finds the terminal can arbitrarily make or place calls using the mobile terminal. Accordingly, the user who lost the phone generally has to pay for these calls. In addition, users generally store personal information within their mobile terminals. This personal information may also be viewed by someone who finds the lost terminal.

### SUMMARY OF THE INVENTION

Accordingly, one object of the present invention is to address the above-noted and other problems.

Another object of the present invention is to allow a user to remotely control their terminal by issuing a command from another terminal, thereby disabling a desired function on their terminal.

To achieve these and other advantages and in accordance with the purpose of the present invention, as embodied and broadly described herein, the present invention provides in one aspect a mobile communication method including a transmitting to a network, at a first terminal, a message including a control command for controlling a service of a second terminal, and controlling the service of the second terminal according to the control command.

According to another aspect, the present invention provides a mobile communication terminal including a transceiver configured to transmit a message including a control command for controlling a service of another terminal to a network, and a control unit configured to control the service of the second terminal according to the control command.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this specification, illustrate embodiments of the invention and together with the description service to explain the principles of the invention.

In the drawings:

FIG. 1 is a flow diagram showing message flows between first and second terminals and a network in accordance with an embodiment of the present invention;

FIG. 2 is a flowchart showing a method for controlling a mobile terminal in accordance with an embodiment of the present invention;

FIG. 3 is a flow diagram showing message flows between first and second terminals and a network in accordance with another embodiment of the present invention;

FIGS. 4A and 4B are flowcharts showing a method for controlling a mobile terminal in accordance with the other embodiment of the present invention;

FIG. 5 is a block diagram illustrating a mobile terminal in accordance with an embodiment of the present invention;

FIG. 6 is a flow diagram showing message flows between a first terminal and a network in a method for controlling a mobile communication service in accordance with an embodiment of the present invention; and

FIG. 7 is a flowchart showing the method for controlling the mobile communication service in accordance with the embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

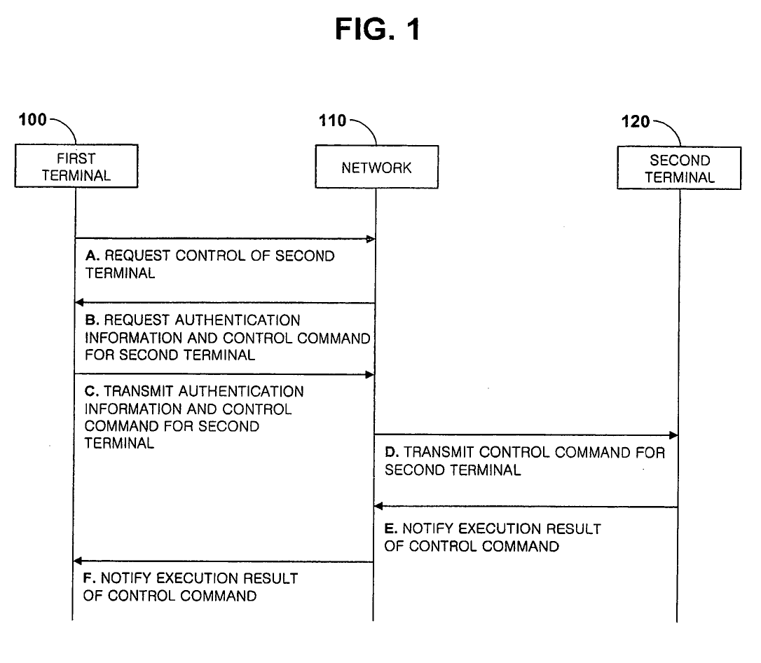

FIG. 1 is a flow diagram illustrating message flows between first and second terminals and a network in a method for controlling the second terminal in accordance with an embodiment of the present invention. In this example, the second terminal is the user's terminal and the first terminal is another terminal the user is using to control his or her own second terminal.

As shown, the first terminal 100 transmits to the network 110 an Unstructured Supplementary Services Data (USSD) message (message A) requesting control of the second terminal 120. The network 110 then transmits a USSD message (message B) to the first terminal 100 requesting authentication information from the user of the first terminal 100. The authentication information is information that allows the user to control the second terminal 120. The network 110 also request in the message B that the first terminal transmit a control command (e.g., block all calls, etc.).

Then, the user enters the appropriate authentication information (e.g., password, terminal number, account information, etc.) and the appropriate control command. The first terminal 100 then transmits this information to the network 110 in another USSD message (message C). The network 110 then determines whether or not the user has control over the second terminal 120 based on the received authentication information. When the authentication information is identical to authentication information registered in the network 110, the network 110 transmits a USSD message (message D) including the control command to the second terminal 120.

The second terminal 120 then executes an operation corresponding to the control command and transmits a USSD message (message E) notifying the execution result to the network 110. The network 110 then transmits a USSD message (message F) including the execution result to the first terminal 100, thereby notifying the user about the execution result. Thus, the user is able control his or her terminal by transmitting information from another terminal.

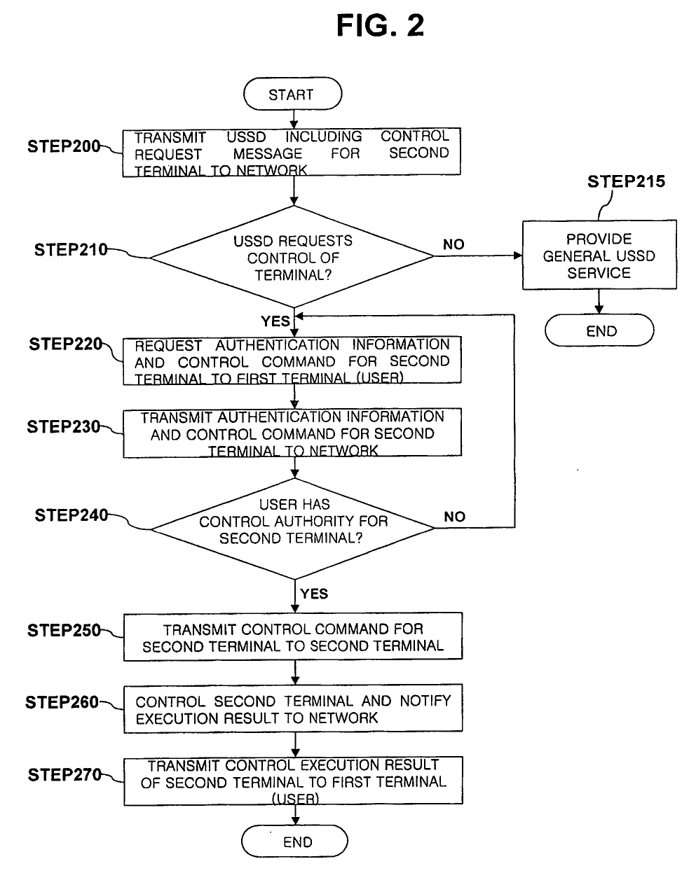

Turning now to FIG. 2, which is a flowchart showing a method for controlling a mobile communication terminal in accordance with an embodiment of the present invention. FIG. 1 will also be referred to in this description. As shown in FIG. 2, the method includes transmitting, at the first terminal 100, a USSD message to the network 110 (Step 200). The USSD message includes control information requesting control of the second terminal 120. Then, the network 110 then receives the USSD message and determines whether or not the received USSD message is a general USSD message or a USSD message requesting control of the second terminal 120 (Step 210).

If the USSD message is a general message (No in Step 210), a general USSD process is provided (Step 215). A general USSD process relates to obtaining current time information, weather information, stock price information, performing an instant message service, etc.

However, if the USSD message is requesting control of the second terminal 120, the network 110 requests the appropriate authentication information and control command from the user using the first terminal 100 (Step 220). The input authentication information and control command are then transmitted to the network 110 (Step 230), and the network 110 determines if the user of the first terminal 100 has the authority to control the second terminal 120 based on the authentication information (Step 240).

The requested authentication information can be a subscriber number of the second terminal 120, a resident registration number or an authentication code preset by the user. Also, the control command input into the first terminal 110 corresponds with a control command stored at the network 110. For example, the control command may request the second terminal 120 be locked or restricted to prevent using the terminal or reading information stored in the terminal, to setup/cancel a call blocking feature, setup/cancel a data communication blocking feature, a call-forwarding feature, to display a contact number of the user on a display of the second terminal 120, etc.

When the authentication information is identical to the authentication information registered in the network 110 (Yes in Step 240), the network 110 transmits a USSD message including the control command to the second terminal 120 (Step 250). However, if the authentication information does not match the authentication information registered in the network (No in Step 240), the process returns to Step 210 and the user is given another chance to enter the correct authentication information. In addition, the network 110 can limit the number of times a user can attempt to provide the correct authentication information for security reasons. Accordingly, when the number of attempts exceeds a preset number, the network 110 terminates the process.

After the control command is transmitted to the second terminal 120, the second terminal 120 executes the control command included in the USSD message and notifies the network 110 about a result of the execution (e.g., the execution was successful). The network 110 then transmits the results to the first terminal 100 using another USSD message so as to notify the user about whether the control command was successfully executed, etc. (Step 270). Also, the second terminal 120 can execute a control function by activating a corresponding key related to the control function (e.g., by activating a lock key to lock the terminal, etc.).

Therefore, when a user loses or misplaces his or her terminal, he or she can actively prevent other people from using the second terminal 120. In addition, if the user left his or her terminal at the office or home, for example, the user can remotely control the phone to deactivate it, for example, until he or she retrieves the terminal. The user can also control his or her terminal remotely in other appropriate situations.

In addition, many types of terminals provide a USSD service. For example, a hand held mobile terminal, a PSTN terminal and a personal computer provide a USSD service and thus can be used as the first terminal 100. In addition, the control request message transmitted to the network 110 is variable and set by the network 110. For example, the length of the control message is set by the network 110. The control request message also preferably includes information identifying the terminal (e.g., a mobile service subscriber number of the terminal to be controlled) so the network 110 recognizes the terminal which the first terminal 100 intends to control.

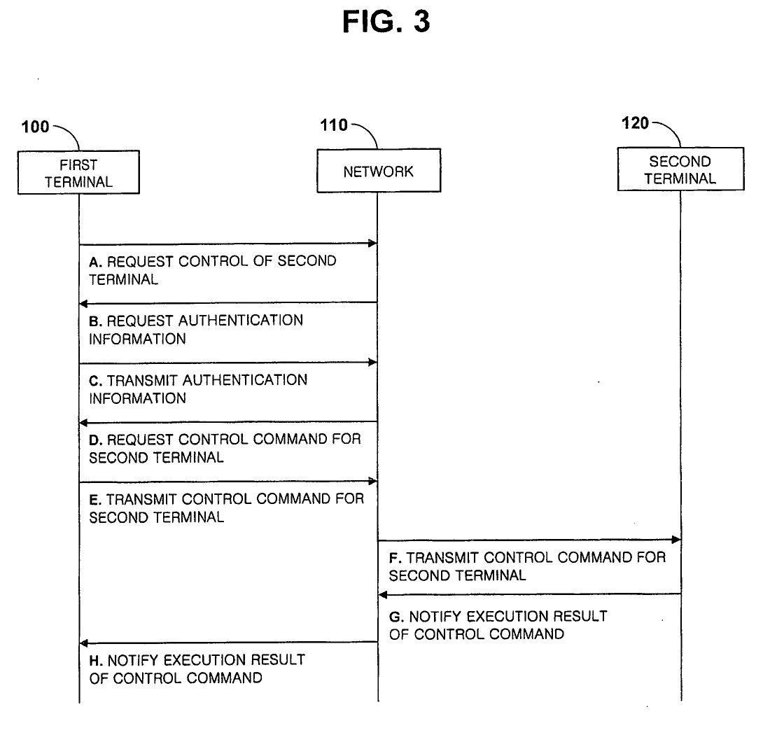

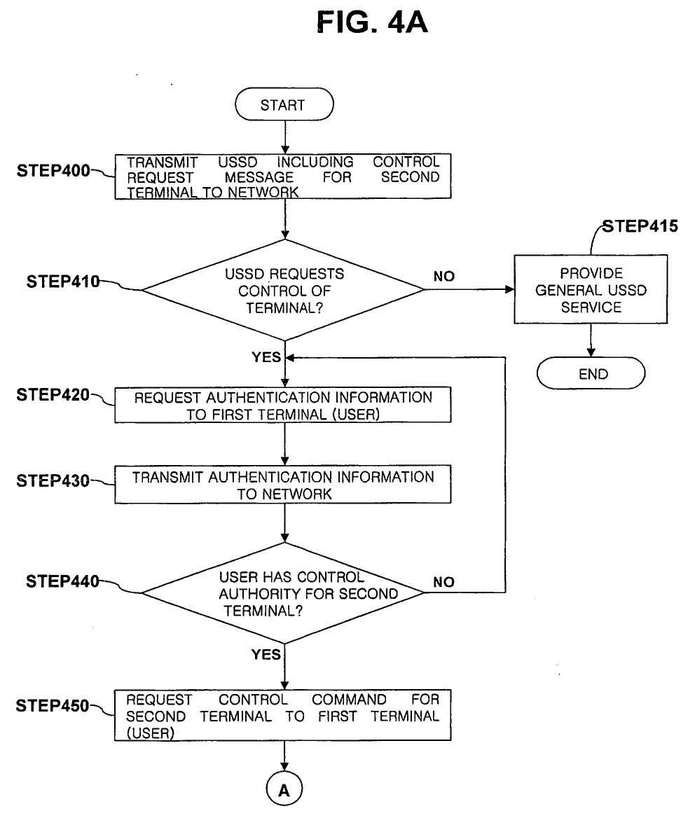

Turning now to FIGS. 3 and 4, which illustrate a method of controlling a terminal in accordance with another embodiment of the present invention. FIG. 1 will also be referred to in this description. In this embodiment, the authentication information and control command steps are individually carried out.

In more detail, FIG. 3 is a flow diagram showing message flows between the first and second terminals 100 and 120 and the network 110. As shown, this embodiment is similar to FIG. 1, except the steps of requesting/transmitting authentication and control information are performed separately. That is, the first terminal 100 transmits a USSD message (message A) requesting control of the second terminal 120 to the network 110, and the network 110 transmits a USSD message (message B) requesting authentication information to the first terminal 100.

The user then inputs the authentication information and the first terminal 100 transmits a USSD message (message C) including the authentication information to the network 110, and the network 110 determines whether or not the user has authority over the second terminal 120 based on the received authentication information. When the authentication information is identical to authentication information registered in the network 110, the network 110 transmits a USSD message (message D) to the first terminal 100 requesting the user enter a control command for the second terminal 120.

When the user enters the control command, the first terminal 100 transmits a USSD message (message E) including the control command to the network 110, and the network 110 transmits a USSD message (message F) including the control command to the second terminal 120. The second terminal 120 then executes an operation corresponding to the control command and transmits a USSD message (message G) notifying the execution result to the network 110, and the network 110 transmits a USSD message (message E) including the execution result to the first terminal 100, thereby notifying the execution result to the user.

FIGS. 4A and 4B are flowcharts showing the method for controlling the mobile terminal in accordance with this embodiment of the present invention. As shown, the method includes transmitting, at the first terminal 100, a USSD message including a message requesting control of the second terminal 120 to the network 110 (Step 400), and the network 110 determines whether the received USSD is a general USSD message or a USSD message requesting control of the terminal (Step 410). If the message is a general USSD message (No in Step 410), a general USSD process is performed (Step 415).

However, if the network 110 determines the USSD message is the control message (Yes in Step 410), the network 110 transmits a USSD message requesting authentication information of the user on the first terminal 100 (Step 420), and when the user enters the authentication information, the first terminal 100 transmits the requested authentication information to the network 110 (Step 430). The network 110 then determines whether the authentication information is correct (Step 440). If the information is not correct (No in Step 440), the step 420 is repeated to allow the user to again input the authentication information. As discussed above, the network 110 can limit the amount of times the user may be able to enter authentication information for security reasons.

In addition, when the authentication information is correct (Yes in Step 440), the network 110 transmits a USSD message to the first terminal 100 requesting the user enter a control command for controlling the second terminal 120 (Step 450). The user then enters the control command, and the first terminal 100 transmits a USSD message including the control command to the network 110 (Step 460). The network 110 then transmits a USSD message including the control command to the second terminal 120 (Step 470).

The second terminal 120 then executes an operation corresponding to the control command and notifies the network 110 about a result of the execution (Step 480). Finally, the network 110 transmits the result to the first terminal 100 (Step 490). Thus, this embodiment is similar to the embodiment discussed in FIG. 2, except the authentication and control command steps are performed separately.

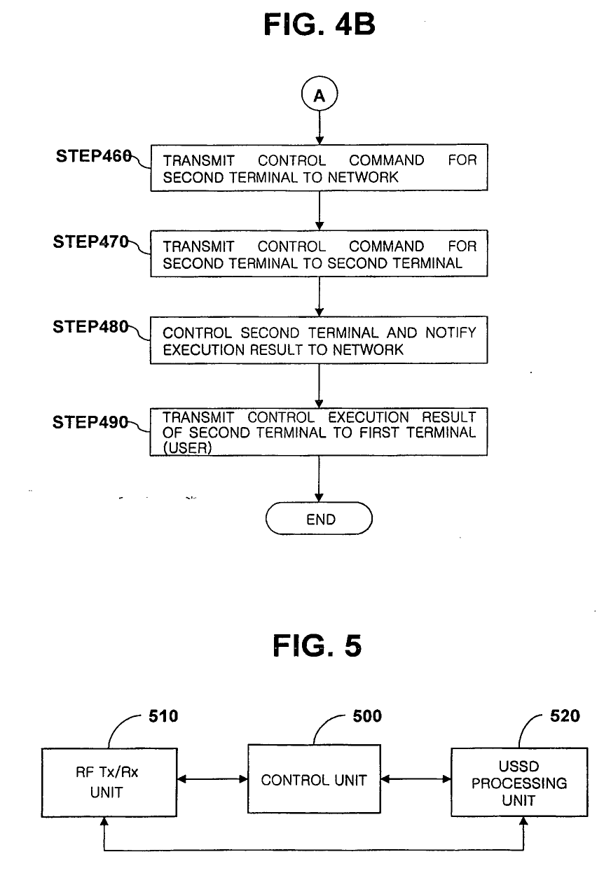

Turning now to FIG. 5, which is a block diagram illustrating an apparatus for controlling a mobile terminal in accordance with an embodiment of the present invention. Referring to FIG. 5, the apparatus includes a radio frequency transmitting/receiving unit 510 for transmitting or receiving USSD messages to and from the network 110, and an USSD processing unit 520 for receiving the USSD messages, extracting a control command, and transmitting the extracted control command to a control unit 500. In addition, the control unit 500 is for receiving the extracted control command, and controls an operation of the terminal corresponding to the received control command.

Further, the control unit 500 can directly control the operation of the terminal corresponding to the control command, or can control the operation of the terminal by using a special terminal control unit, preset key, etc. In addition, after controlling the operation of the terminal, the control unit 500 transmits a USSD message including the control result to the network 110 through the USSD processing unit 520.

In addition, the control unit 500 can perform several different control operations such as blocking an input unit such as a keypad, setting up and canceling a call blocking feature, setting up and canceling an Internet access blocking feature, setting up and canceling a data service access blocking feature, establishing call-forwarding to another terminal designated by the user, restricting data stored in the terminal from being read, and displaying a contact number of a terminal owner on a display screen. Preferably, the control operations are distinguished by preset USSD messages.

In addition, the USSD processing unit 520 determines whether or not a received USSD message is a general USSD message or a USSD control message for controlling the terminal by analyzing/decoding the USSD message received by the terminal, and notifies the decision result to the control unit 500. Also, the USSD processing unit 520 receives the control result from the control unit 500, generates a USSD message including the control result, and transmits the USSD message to the network 110 through the radio frequency transmitting/receiving unit 510. Preferably, the apparatus for controlling the mobile terminal is installed in the terminal to be controlled.

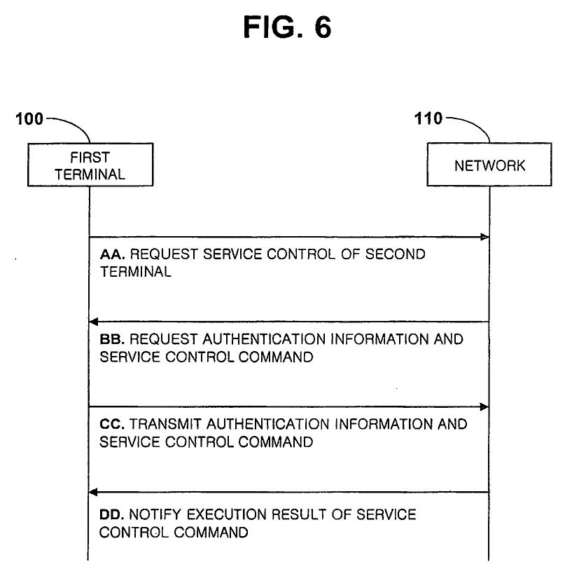

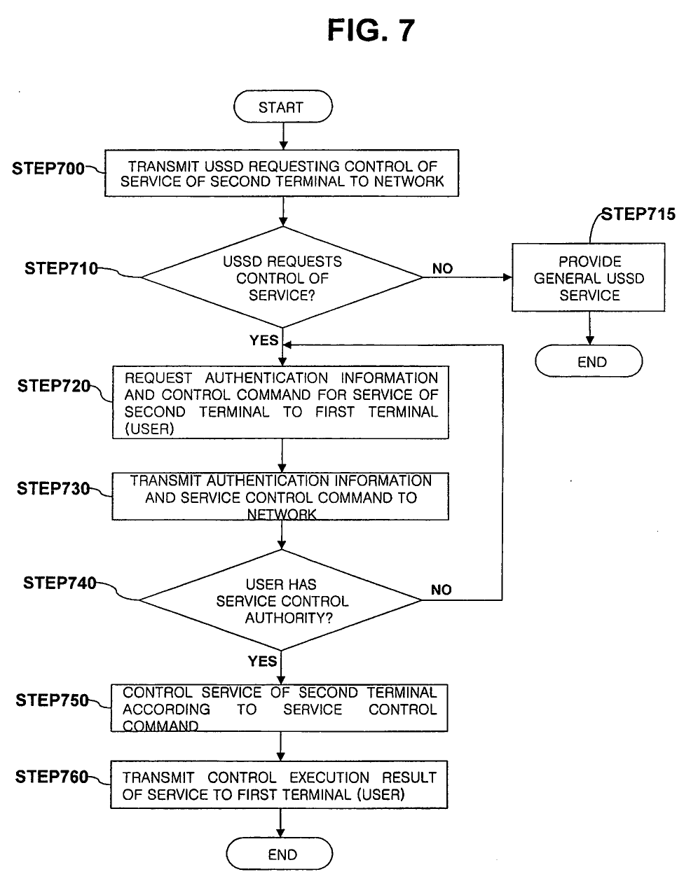

A method for controlling a mobile communication service in accordance with an embodiment of the present invention will now be described with reference to FIGS. 6 and 7. As shown in FIG. 6, the first terminal 100 transmits a USSD message (message AA) requesting control of the second terminal 120 to the network 110, and the network 110 transmits a USSD message (message BB) requesting authentication information and a control command to the first terminal 100.

When the user inputs the requested information, the first terminal 100 transmits a USSD (message CC) including the authentication information and the service control command to the network 110, and the network 110 determines whether or the user input the correct authentication information. When the authentication information is correct, the network 110 controls the service of the second terminal 120 according to the received service control command. Then a result of the execution is transmitted to the first terminal 100 using a USSD message (message DD).

In the method for controlling the mobile communication terminal, the first terminal directly controls the operation of the second terminal through the network. On the other hand, in the method for controlling the mobile communication service, the first terminal uses the network to control the service provided to the second terminal.

Turning now to FIG. 7, which is a flowchart showing a method for controlling a mobile communication service in accordance with an embodiment of the present invention. FIG. 6 will also be referred to in this description. As shown in FIG. 7, the method includes transmitting, at the first terminal 100, a USSD message to the network 110 (Step 700). The USSD message includes control information requesting control of the second terminal 120. Then, the network 110 receives the USSD message and determines whether or not the received USSD message is a general USSD message or a USSD message requesting control of the second terminal 120 (Step 710).

If the USSD message is a general message (No in Step 710), a general USSD process is provided (Step 715). As discussed above, the general USSD process relates to obtaining current time information, weather information, stock price information, performing an instant message service, etc.

However, if the USSD message is requesting control of the second terminal 120 (Yes in Step 710), the network 10 requests the appropriate authentication information and control command from the user using the first terminal 100 (Step 720). The input authentication information and control command are then transmitted to the network 110 (Step 730), and the network determines if the user of the first terminal has the authority to control the second terminal 120 based on the authentication information (Step 740).

When the authentication information is identical to authentication information registered in the network 110 (Yes in Step 740), the network 110 controls the second terminal 120 based on the control information (Step 750). However, if the authentication information does not match the authentication information registered in the network (No in Step 740), the process returns to Step 710 and the user is given another chance to enter the correct authentication information. In addition, the network 110 can limit the number of times a user can attempt to provide the correct authentication information for security reasons. Accordingly, when the number of attempts exceeds a preset number, the network 110 can terminate the process.

After the network controls the second terminal 120, the network 110 transmits the results to the first terminal 100 using another USSD message so as to notify the user about whether the control command was successfully executed, etc. (Step 760).

In addition, the control request message, the authentication information and the control command using USSD messages are preferably transmitted from the first terminal 100 to the network 110 using individual USSD messages. In addition, the control request message, the authentication information and the control command can be transmitted at the same time using a single USSD message. The network 110 analyzes the received USSD message, executes a corresponding operation, and controls the second terminal 120 and the mobile communication service based on the control command in the control USSD message.

Thus, in accordance with the present invention, the mobile communication terminal and corresponding service can be controlled by a user to prevent other people from using their terminal. The user can also actively change or modify certain features on their terminal using the USSD messages. In addition, because the mobile terminal and corresponding service are controlled by the user using USSD messages, even if the user loses his/her mobile communication terminal, the user can easily and rapidly control and restrict use of their terminal.

Also, the user does not have to access a special menu to request control of their mobile terminal. That is, the user can easily control their mobile terminal by inputting a simple command. Here, the control commands can be stored in a storing unit of the mobile terminal, and thus easily used by the user. In addition, a Subscriber Identity Module (SIM) which supports the USSD service can be used in the terminals of the present invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A mobile communication method, comprising:
transmitting, at a first terminal, a message including a control command for controlling a service of a second terminal to a network; and
controlling the service of the second terminal according to the control command.

2. The method of claim 1, wherein the message comprises an Unstructured Supplementary Services Data (USSD) message.

3. The method of claim 1, wherein the controlling step comprises controlling the service of the second terminal at the network.

4. The method of claim 1, wherein the controlling step comprises controlling the service of the second terminal at the second terminal.

5. The method of claim 1, wherein the control command sets up or cancels a call blocking feature, an Internet access blocking feature, an input unit blocking feature, a data service access blocking or a memory access blocking feature in the second terminal, or the control command displays a contact number of an owner of the second terminal on a display of the second terminal.

6. The method of claim 1, wherein the control command requests calls received by the second terminal be transferred to a preset third terminal.

7. The method of claim 1, further comprising:
determining whether or not a user of the first terminal has authority to control the service of the second terminal; and
controlling the service of the second terminal according to the control command based on a result of the determining step.

8. The method of claim 7, wherein the determining step comprises:
requesting authentication information from the user of the first terminal; and
determining whether or not the authentication information input by the user of the first terminal matches with a predetermined authentication information for the second terminal.

9. The method of claim 8, further comprising:
controlling the service of the second terminal when the authentication input by the user of the first terminal matches with the predetermined authentication information; and
re-requesting the authentication information from the user of the first terminal a limited number of times when the authentication input by the user of the first terminal does not match with the predetermined authentication information.

10. The method of claim 1, further comprising:
notifying a result of controlling step to the first terminal.

11. A mobile communication terminal, comprising:
an transceiver configured to transmit a message including a control command for controlling a service of another terminal to a network; and
a control unit configured to control the service of the second terminal according to the control command.

12. The terminal of claim 11, wherein the message comprises an Unstructured Supplementary Services Data (USSD) message.

13. The terminal of claim 11, wherein the control unit controls the service of the other terminal at the network.

14. The terminal of claim 11, wherein the control unit controls the service of the second terminal at the other terminal.

15. The terminal of claim 11, wherein the control command sets up or cancels a call blocking feature, an Internet access blocking feature, an input unit blocking feature, a data service access blocking or a memory access blocking feature in the other terminal, or the control command displays a contact number of an owner of the second terminal on a display of the other terminal.

16. The terminal of claim 11, wherein the control command requests calls received by the second terminal be transferred to a preset third terminal.

17. The terminal of claim 11, further comprising:
an input unit configured to receive authentication information used to determine whether or not a user of the terminal has authority to control the service of the other terminal.

18. The terminal of claim 17, wherein the control unit controls the service of the second terminal when the authentication input by the user of the first terminal matches with predetermined authentication information.

19. The terminal of claim 18, wherein the control unit re-requests the user enter the authentication information on the input unit of the first terminal a limited number of times when the authentication input by the user does not match with the predetermined authentication information.

20. The terminal of claim 11, wherein the control unit notifies a result of whether or no the service of the other terminal was successfully controlled.
